(19) United States
(12) Patent Application Publication
(10) Pub. No.: US 2013/0218725 A1
(43) Pub. Date: Aug. 22, 2013

(54) MULTI-COMPONENT SELECTION SYSTEM AND METHOD

(71) Applicants: Austin Lennon Kettner, Akron, OH (US); James Leland Hilton, Akron, OH (US); Jack Lowell Hilton, Akron, OH (US)

(72) Inventors: Austin Lennon Kettner, Akron, OH (US); James Leland Hilton, Akron, OH (US); Jack Lowell Hilton, Akron, OH (US)

(73) Assignee: QUIXBY, LLC, Cleveland, OH (US)

(21) Appl. No.: 13/775,030

(22) Filed: Feb. 22, 2013

Related U.S. Application Data
(60) Provisional application No. 61/601,770, filed on Feb. 22, 2012.

(51) Int. Cl. G06Q 30/06

(52) U.S. Cl. CPC G06Q 30/0631
USPC 705/26.63; 705/26.62

(57) ABSTRACT

A system and method consistent with the present disclosure includes collecting a plurality of information associated with components sold by a plurality of vendors. In response from a requester requesting component recommendations from a system and method consistent with the present disclosure, retrieving the collected component information of the components relevant to the request. Finally, communicating the retrieved component information as component recommendations to the requester.

### CROSS REFERENCE TO RELATED APPLICATIONS

The present patent application claims priority to and benefit of U.S. Provisional Application Ser. No. 61/601,770 filed Feb. 22, 2012 by Austin Kettner et al. entitled “Multi-Component Selection Device and Method,” the entire contents of which are hereby specifically incorporated by reference for all it discloses and teaches.

### FIELD

The present disclosure relates to a system and method for recommending components, such as parts, for a custom design system to consumers.

### BACKGROUND

Today, due to the vast amount of product information targeted to consumers, consumers do not have enough time to evaluate products before making purchasing decisions. Instead, many consumers are ill-prepared and rely on marketing and commercial advertisements when purchasing full configured systems or replacement parts.

For example, consumers often make poor purchasing choices when buying accessories or replacement parts for systems they currently own. Furthermore, many consumers lack the technical sophistication to build custom design systems for their business or personal needs.

Therefore, what is needed is a system and method to retrieve component information from various vendors and provide component recommendations in response to consumer preference(s). The present disclosure addresses such a need.

### SUMMARY OF THE DISCLOSURE

The following summary is included in order to provide a basic understanding of some aspects and features of the present disclosure. This summary is not an extensive overview of the disclosure and as such it is not intended to particularly identify key or critical elements of the disclosure or to delineate the scope of the disclosure. Its sole purpose is to present some concepts of the disclosure in a simplified form as a prelude to the more detailed description that is presented below.

A system and method consistent with the present disclosure includes collecting a plurality of information associated with components sold by a plurality of vendors. In response from a requester requesting component recommendations from a system and method consistent with the present disclosure, retrieving the collected component information of the components relevant to the request. Finally, communicating the retrieved component information as component recommendations to the requester.

### BRIEF DESCRIPTION OF THE DRAWINGS

To facilitate understanding, identical reference numerals have been used, where possible, to designate identical elements that, are common to the figures. The drawings are not to scale and the relative dimensions of various elements in the drawings are depicted schematically and not necessarily to scale.

FIG. 1 is a schematic illustrating an exemplary embodiment of the present disclosure in an exemplary operating environment;

FIG. 2 describes a method consistent with embodiments of the present disclosure;

FIG. 3 is a schematic illustrating an exemplary display for prompting users for component preferences;

FIG. 4 is a schematic illustrating an exemplary display of price, vendor, and availability of components presented to a user based on user preference(s);

FIG. 5 is schematic illustrating an exemplary display of component details of a single component available for purchase;

FIG. 6 is a schematic which illustrates components recommended to a user based on the user's previous selection;

FIG. 7 is a schematic illustrating an exemplary display of a user's shopping cart which contains components from a first vendor; and

FIG. 8 is a schematic illustrating an exemplary display of an alternative build in which components from the first vendor are replaced with similar components from a second vendor.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. The described techniques may be practiced according to the claims without some or all of these specific details. For the purpose of clarity, technical material that is known in the technical fields related to the embodiments has not been described in detail to avoid unnecessarily obscuring the description.

A system and method consistent with the present disclosure includes collecting a plurality of information associated with components sold by a plurality of vendors. In response from a requester requesting component recommendations from a system and method consistent with the present disclosure, retrieving the collected component information of the components relevant to the request. Finally, communicating the retrieved component information as component recommendations to the requester.

The present disclosure, as demonstrated by the exemplary embodiments described below, provides a system and method for a user to request and receive component recommendations based upon user preference(s). In some embodiments, a user can request component recommendations for components or parts for a system the user current owns. In yet other embodiments, a user can request component recommendations for a series of components to custom build a system (e.g. personal computer, gaming computer system, laptop, touch screen device, vehicle, custom-built home, or books, etc.).

It should be noted that the term “user” may be used throughout the disclosure to indicate one who interfaces with a system consistent with the present disclosure. A user may be referred to herein as a consumer, visitor, or requester. As such, the terms user, consumer, visitor, and requester may be used interchangeably throughout this disclosure.

Further, the term “component” may refer to any product that is recommended or presented to a user based on the user's preference(s). Moreover, the term component, product, part or the like may be used interchangeably throughout this disclosure.

A user can solicit component recommendations based on the user's technical, functional, or aesthetic preferences. For example, a user can utilize a system consistent with the present disclosure to identify tires, filters, or other parts compatible with a user's vehicle.

In other embodiments, a user may solicit component recommendations based on aesthetic attributes. For instance, consumers of home appliances may retrieve component recommendations for various appliances which match the layout or design inside of the user's home (e.g. rooms). Moreover, users can retrieve component recommendations of other books based on the user's personal book collection. Accordingly, a system and method consistent with the present disclosure can be applied in various manners and in numerous operating environments.

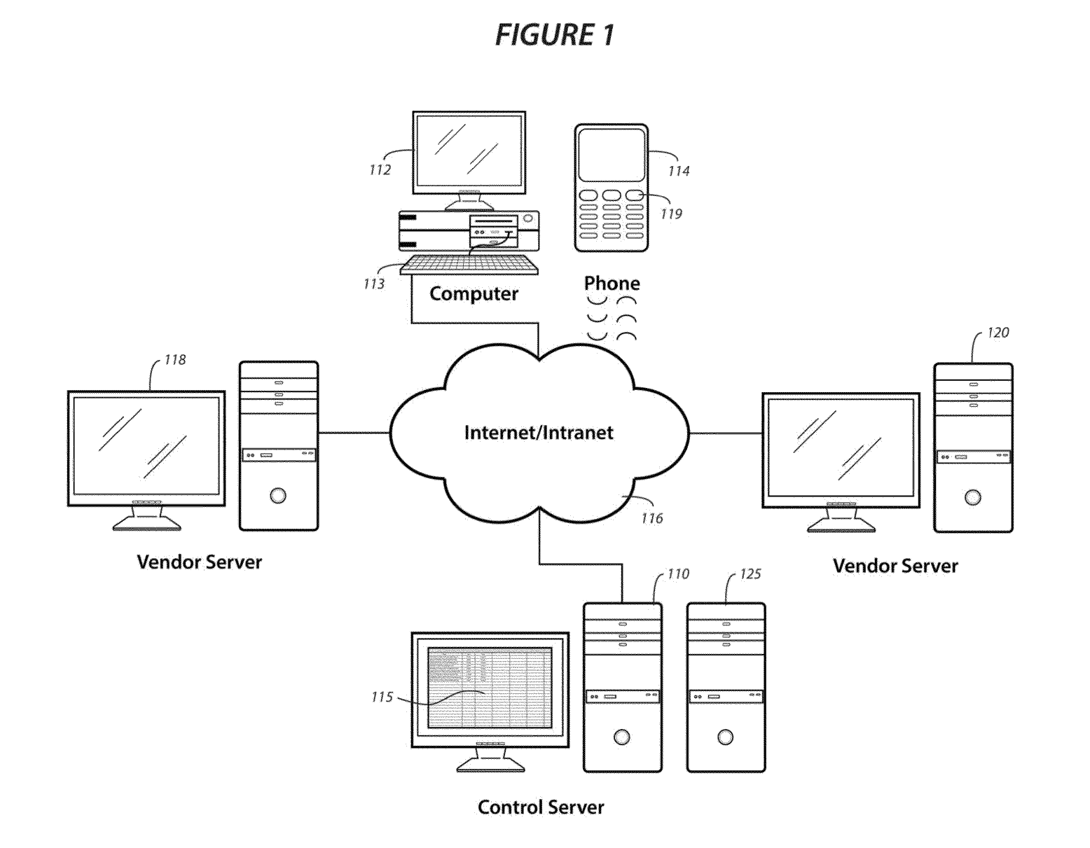

FIG. 1 is a schematic illustrating an exemplary embodiment of the present disclosure in an exemplary operating environment. As shown, a control server 110 is linked to a user's computer 112, mobile electronic device 114, tablet (not shown) or the like via a network 116 such as the Internet or an intranet to facilitate communication. As such, in the embodiment shown, the user's computer 112 and mobile electronic device 114 are client devices of the control server 110.

The control server 110 can include multiple processors and hard disks. The control server 110 may operate web server software configured according to any particular platform such as Apache Server, Microsoft ISS, Google GWS, lighttpd, or nginx. Notably, control server 110 employs software applications to execute the functionality set forth below.

Control server 110 may be coupled to vendor servers 118, 120 through network 16. Although only two vendor servers are shown in the figure, one having ordinary skill in the art may appreciate that control server 110 may be coupled to more or less than two vendor servers. In some embodiments of the present disclosure, control server 110 extracts or retrieves component information, or the like, from the vendor servers 118, 120.

In some embodiments, a system consistent with the present disclosure includes a control server 110 has a processor (not shown) to execute programming instructions contained within memory, a user's communication system having an input device (e.g. keyboard 113 or input keys 119) to submit information (e.g. user preferences) to control server 110, and an output device component of the user's computer to display component recommendations, component options, user prompts, or the like.

In some embodiments, control server 110 remains constantly live (e.g. “powered up”) and connected to the Internet. Control server 110 may host a website, accessible to users all over the world, to retrieve component recommendations based on user preference(s). In addition, visitors to the website hosted by control server 110 may interact with users via user prompts on the site as will be explained below.

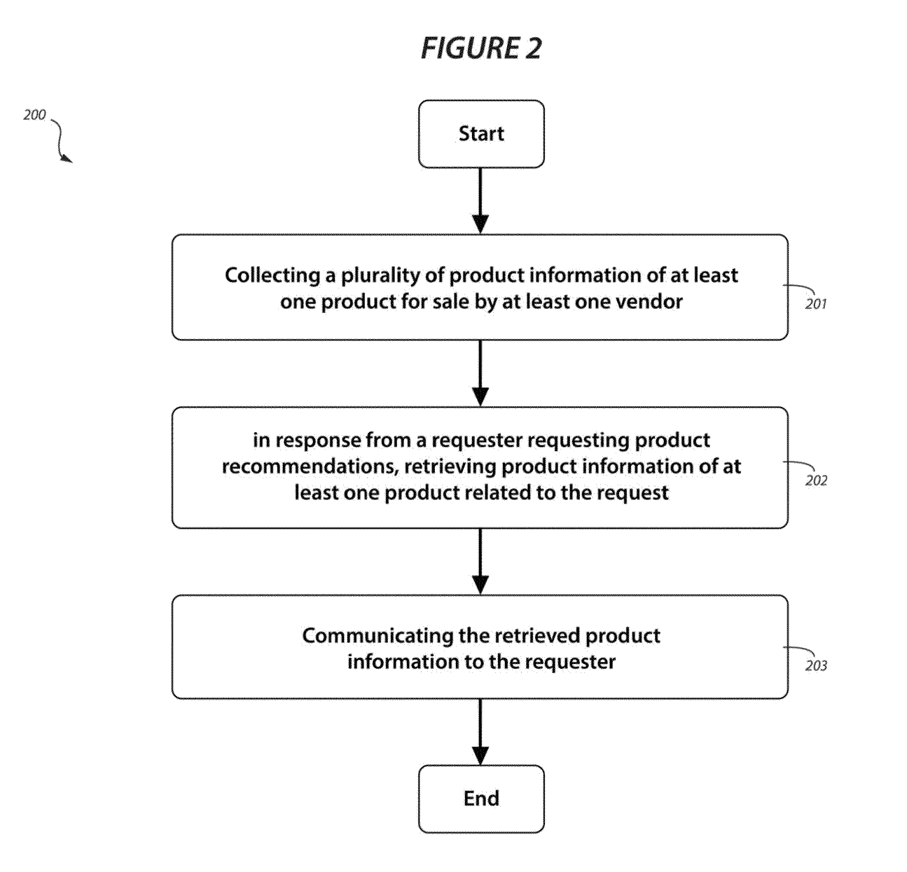

FIG. 2 describes a method 200 consistent with embodiments of the present disclosure. While describing method 200, components illustrated in FIG. 1 will be referenced.

In some embodiments, method 200 begins with block 201 collecting component information of components sold by a plurality of vendors.

Exemplary component information collected from the vendors includes price, component quantity, retailer information, technical specifications or the like. In addition, “vendors” as used herein may include retailers, wholesalers, manufacturers, or any entity which sells goods or services commercially to consumers.

Control server 110 can collect component information from the vendor servers according to a set frequency. For example, control server 110 can collect component information once per day, per week, or the like. Likewise, control server 110 may collect component information randomly and according to the discretion and control of a system administrator.

Furthermore, the present disclosure is amenable to allow control server 110 to receive component information from the vendor servers instead of actively “scraping” the vender servers' website(s). For example, a vendor may send component updates and other relevant component information to control server 110 by uploading the data thereto according to the vendor's discretion. In these embodiments, control server 110 may further parse, normalize, or reformat the data before storing it in the database 125.

Control server 110 may communicate with any number of vendor servers. By way of example and not limitation, the number of vendors may be ten, fifty, one hundred, or more. It is expected that embodiments of the present disclosure can be practiced to include the processing capability to interact with any number of vendors to retrieve component information therefrom.

In some embodiments, control server 110 communicates with the vendor servers 118, 120 through an application programming interface (API). An API may include a source code based specification used as an interface by software components to communicate with each other. API may further include specifications for routines, data structures, object classes, and variables.

An API specification may be defined by several different standards, such as an international standard like Posix or by particular developers of APIs such as the Microsoft Windows API, or include libraries of a programming language like the standard template library in C++ or Java API. In some embodiments, vendor servers 118, 120 may have an API which requires control server 110 to parse the retrieved component information.

In some embodiments, control server 110 may communicate directly with the vendor servers 118, 120 or with servers operated by intermediaries. For example, control server 110 can communicate with vendor servers 118, 120 operated by Commission Junction or Linkshare on behalf of the vendors. Accordingly, control server 110 can retrieve information of goods and services sold by vendors according to the manner in which data is exchanged within the affiliate marketing industry.

Control server 110 can download component information in various formats such as XML or HTML file. Control server 110 may also parse the downloaded file using a scraper software application 115 and allocate data appropriately to a database maintained by control server 110. It should be understood by one having ordinary skill in the art that a database may consist of a plurality of memory within the control server 110. Alternatively, a database 125 may be external but accessible to the control server 110 as shown in FIG. 1. Throughout this disclosure, database 125 may refer to an internal or external unit of memory that stores component information, vendor profiles, pairing and compatibility information or the like.

In some embodiments, scraper software application 115 may check database 125 for “low demand components.” A low demand component may be characterized in any preferred way, such as but not limited to a component listed within the database 125 neither recommended to users by control server 110 nor purchased by a user in two years or more.

In some embodiments, when a low demand component is identified within the database 125, the scraper software application 115 may perform a search to determine whether vendors currently sell the component listed in the database 125. If the identified low demand component is not currently sold by vendors, the scraper software application 115 can update the database 125 by removing the low demand component therefrom.

In addition, a scraper software application 115 consistent with the present disclosure can implement vendor aggregation. For example, vendor profiles may be added to the database 125. Advantageously, the scraper software application 115 may standardize component information retrieved from retailers to a common format. As such, the scraper software application 115 allows the database 125 to grow to a full catalog of component information from various vendors.

In some embodiments, each component listed in the database 125 may have component information characterized as “primary” or “secondary” component information. In some embodiments, primary component information includes attributes or features of the components. For example, primary component information may include a component's technical, functional, and aesthetic attributes.

For instance, primary component information for computer memory may include the memory's storage capacity, volatility, accessibility, or addressability. Component information may be retrieved from component specifications, data sheets, or the like for each component logged in the database 125 of the control server 110.

Secondary component information may include price, discounts, shipping cost, availability, etc. A components track recorder subjective market impression may also be characterized as secondary component information. Secondary component information may be retrieved from user reviews in the form of numerical ratings (or number of stars), advertising and marketing materials. One having ordinary skill in the art should appreciate that no manner of preference is given by the terms “primary” or “secondary” component information. As such, primary component information is not necessarily more important than secondary component information.

In some embodiments, control server 110 creates a compatibility list of each component represented in the database 125. The process of creating the compatibility list may be referred to as pairing. For example, if the database 125 contains a list of processors and motherboards, a software application determines and lists which processors and motherboards are compatible with each other.

The pairing process may be applicable to some component categories but not to others. For example, the software application which performs the “pairing” process may be coded to pair certain categories of components. For example, since components labeled “processors” and those labeled “motherboards” are relational, the control server 110, via software application, will determine the compatibility between each processor and motherboard represented in the database. In some embodiments, compatibility information between components may be listed in a separate database (not shown). As such, the pairing process may be initiated by control server 110 based on the categorization of components listed in the database 125.

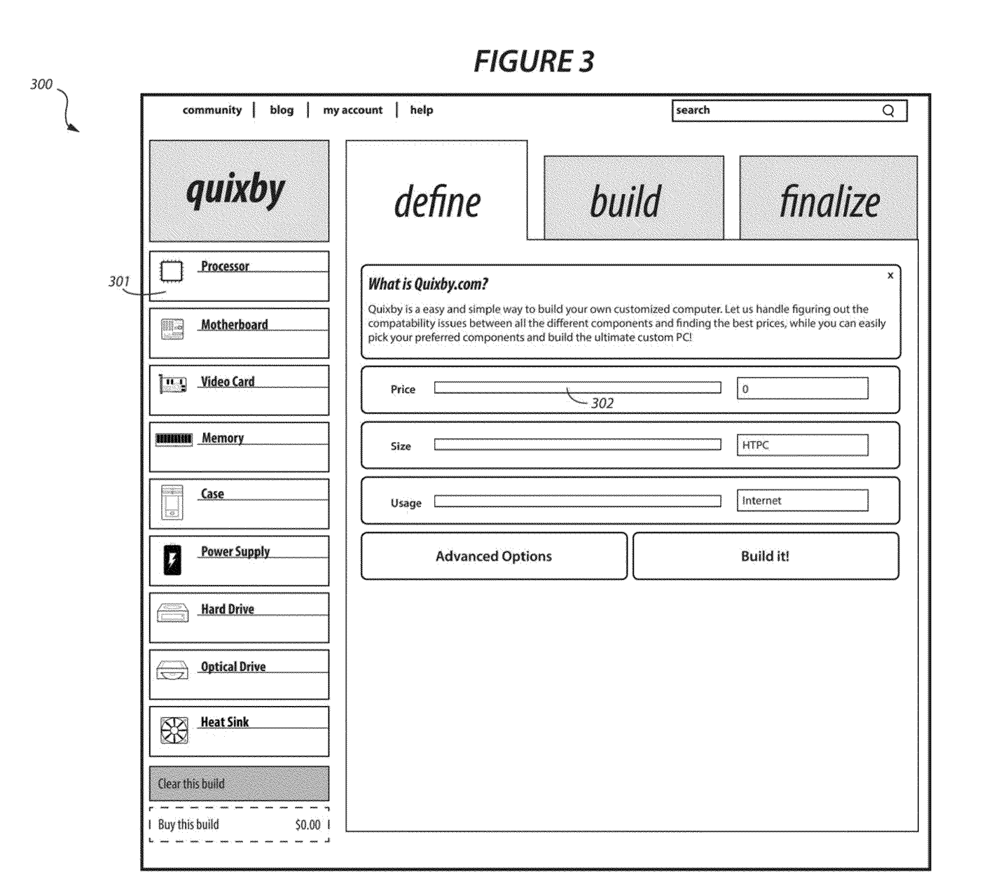

Next, block 202 of method 200 provides that in response from a requester requesting component recommendations, retrieving component information of components relevant to the request, FIG. 3 is a schematic illustrating an exemplary display 300 for prompting user requests of component preference(s) in exchange for component recommendations. Display 300 features prompts for users to submit price, size, and usage preferences in the respective fields 302. It should be understood by one having ordinary skill in the art that the present disclosure is not limited to price, size, and usage fields 302. The present disclosure is amenable to include any of a host of fields 302 to prompt users for component preference(s).

As shown, display 300 illustrates a plurality of icons 301 of computer components of which a user can submit preference(s) for recommendations for any particular kind. User preference(s) may be technical such as a computer processor speed, functional, such as a mouse rather than a keyboard, or aesthetic, such as a particular color of headphones.

By way of example and by no way limiting to the present disclosure, a user may indicate that gaming is the primary function for a custom designed computer system. Control server 110 may thereafter recommend computer components and accessories which (1) provide the optimum gaming experience (2) within the user's budget.

Advantageously, control server 110 may present components to the user based on the order of how critical the component is to the system.

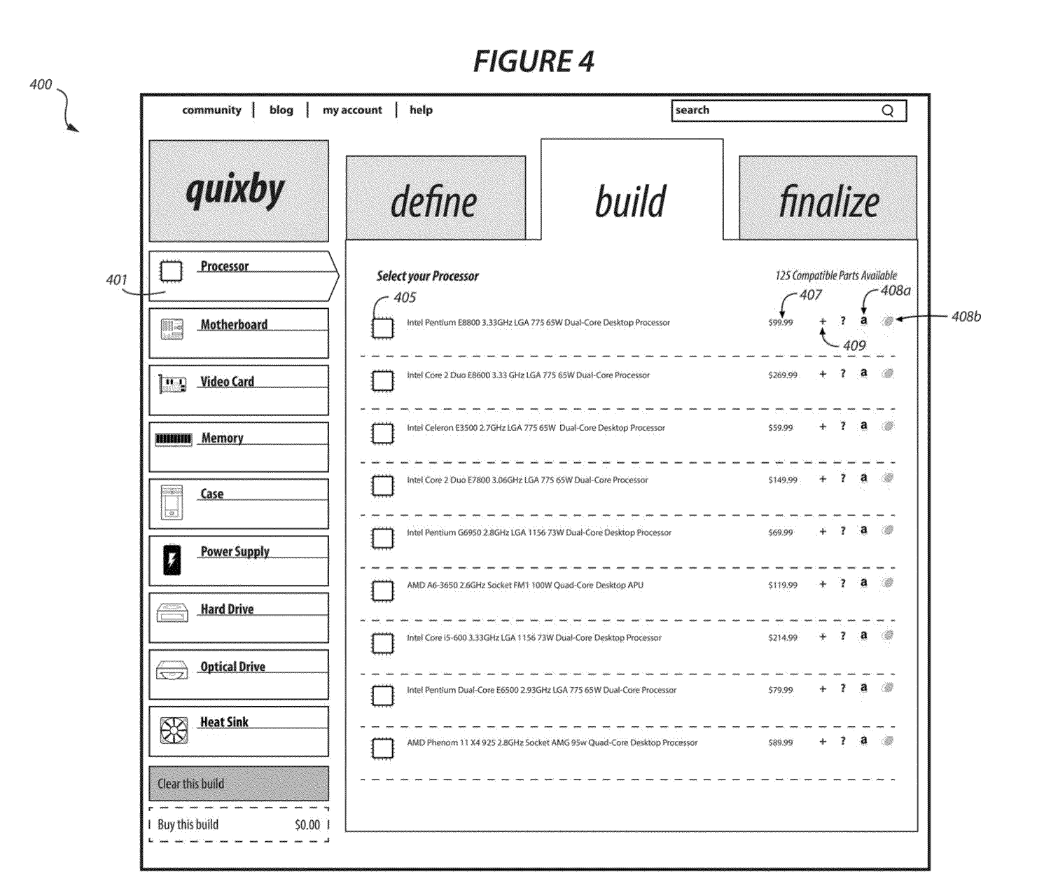

Next, block 203 of method 200 provides communicating retrieved component information to the requester. FIG. 4 is a schematic illustrating an exemplary display 400 of price, vendor, and availability of components presented to a user based on user preference(s). As shown, the display 400 presents a plurality of components available which match or fit within the component description or preference(s) submitted by the user. Furthermore, display 400 indicates the number of components compatible with the components previously selected by the user of each recommended component.

The displayed price 407 may be the lowest price of a particular component type that is offered by any vendor listed in the database 125. For example, although each recommended component shown in the figure is sold by Amazon® or Newegg® only the lowest price between the two retailers 408a, 408b are displayed. A user may make a selection via a keyboard or mouse to obtain additional component details of the component.

In addition, display 400 may include a feature such as the “+” button 409 to add any of the recommended components the user's shopping cart. Control server 110 may execute a “spontaneous build” of components and present users with a custom built system based on production information of components within the database 125.

Display 400 may offer a novice part picker (NPP) feature which may reduce the time a user spends selecting components for a customized system. The NPP feature may recommend components purchased by other consumers in response to preference(s) submitted by a user. For example, control server 110 consistent with a system and method of the present disclosure may recommend a set of components based on compatibility and popularity of the components logged in the database 125.

In addition, display 400 may transmit a message (not shown) to the user such as, by way of example and not limitation, “We noticed that many people who submitted these component preferences also purchased one of these < . . . components . . . >” or “We noticed many positive reviews for these < . . . component . . . >.”

Control server 110 may also present components to the user a logical order. For example, if the user desires to custom design a computer system, control server 110 may present components to the user as follows: processor, motherboard, video card, memory, case, power supply, hard drive, optical drive, and heat sink. Control server 110 can evaluate the components listed in the database 125 and determine which components are the most interchangeable or compatible with other components listed in the database 125.

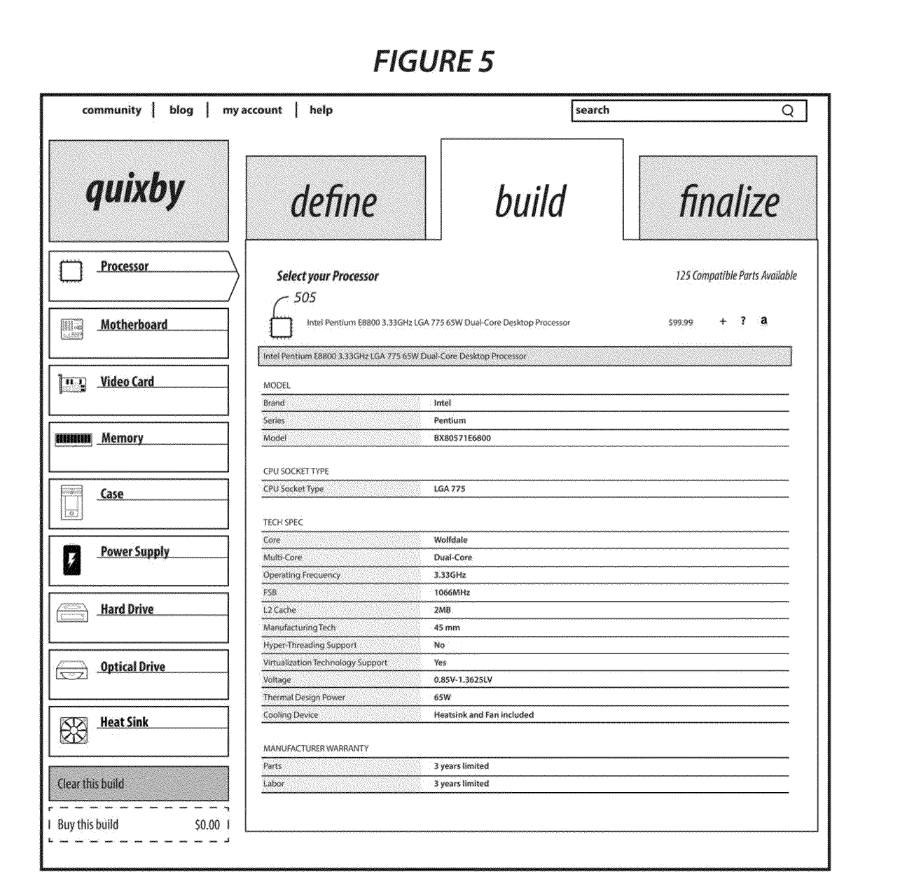

FIG. 5 is schematic illustrating an exemplary display 500 of component details of a single component available for purchase. In FIG. 5, details of Intel's® Pentium E8800 3.33 GHz LGA 775 65W Dual-core Desktop Processor is displayed. Notably, model information, technical specifications, CPU socket type, and the manufacturer's warranty are shown.

Advantageously, a new set of components may be presented to the user after each user selection. In some embodiments, the next set of components may include accessories and may be compatible with the component(s) previously selected by the user.

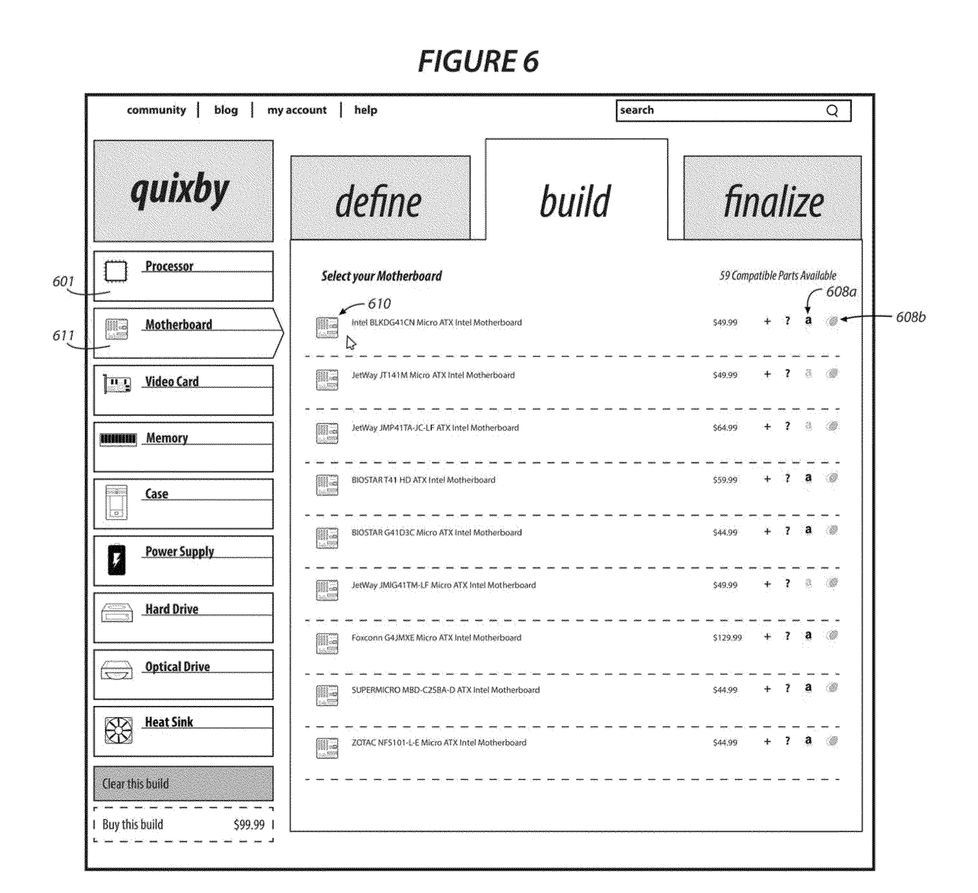

FIG. 6 is a schematic which illustrates components (e.g. motherboard) recommended to a user based on the user's previous selection. In some embodiments, the motherboards presented to the user are compatible with the Intel® Pentium E8800 3.33 GHz LGA 775 65W Dual-core Desktop Processor which was previously selected by a user. According to display 600, fifty-nine compatible motherboards to the Intel® Processor are recommended to the user.

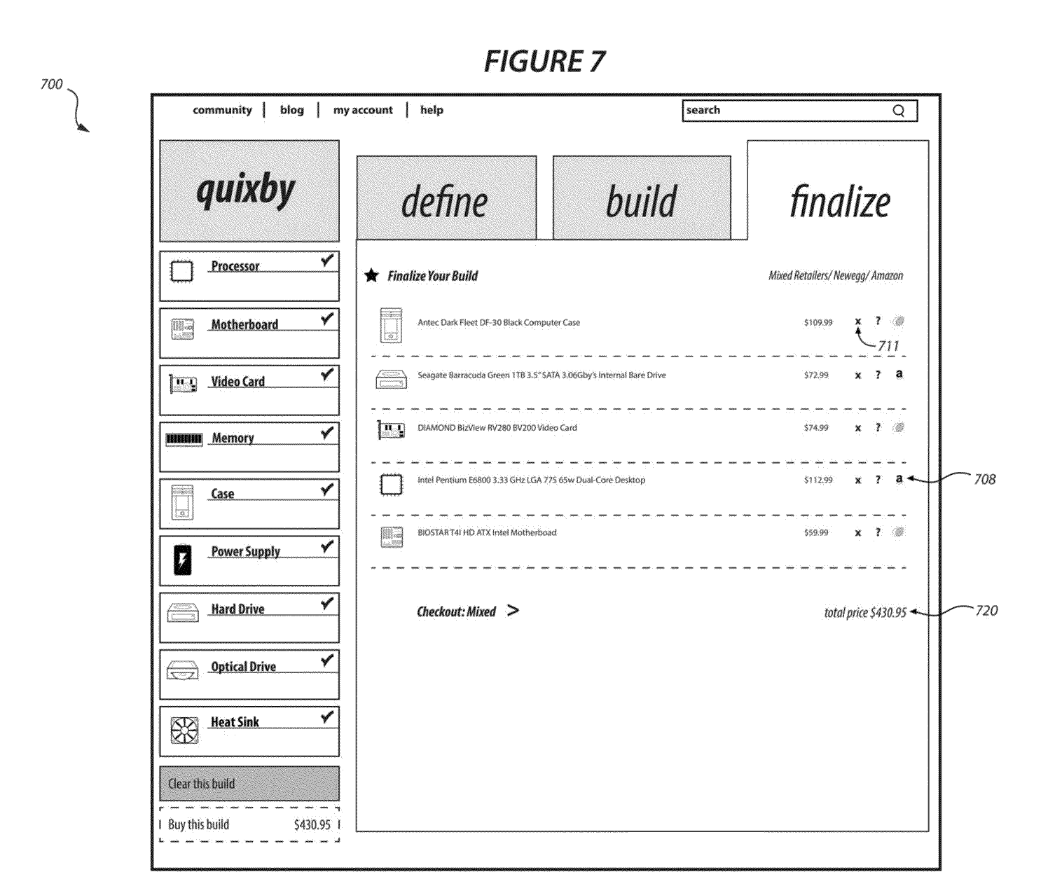

FIG. 7 is a schematic illustrating an exemplary display of a users shopping cart which contains components from various vendor(s). In some embodiments of the present disclosure, upon arrival at the vendor's website(s), the user can purchase the components previously selected.

Display 700 illustrates a list of components of a customized computer system which were previously selected by a user. The user can remove any of the listed components by selecting the “x” button 711.

Control server 110 can replace some of the items on the list displayed with components that have a reduced price, quicker delivery, better features, etc. For example, vendors offer discounts on goods and services from time to time and therefore the discounted components may be more attractive to users. Control server 110 may propose alternative components with an explanation of each change.

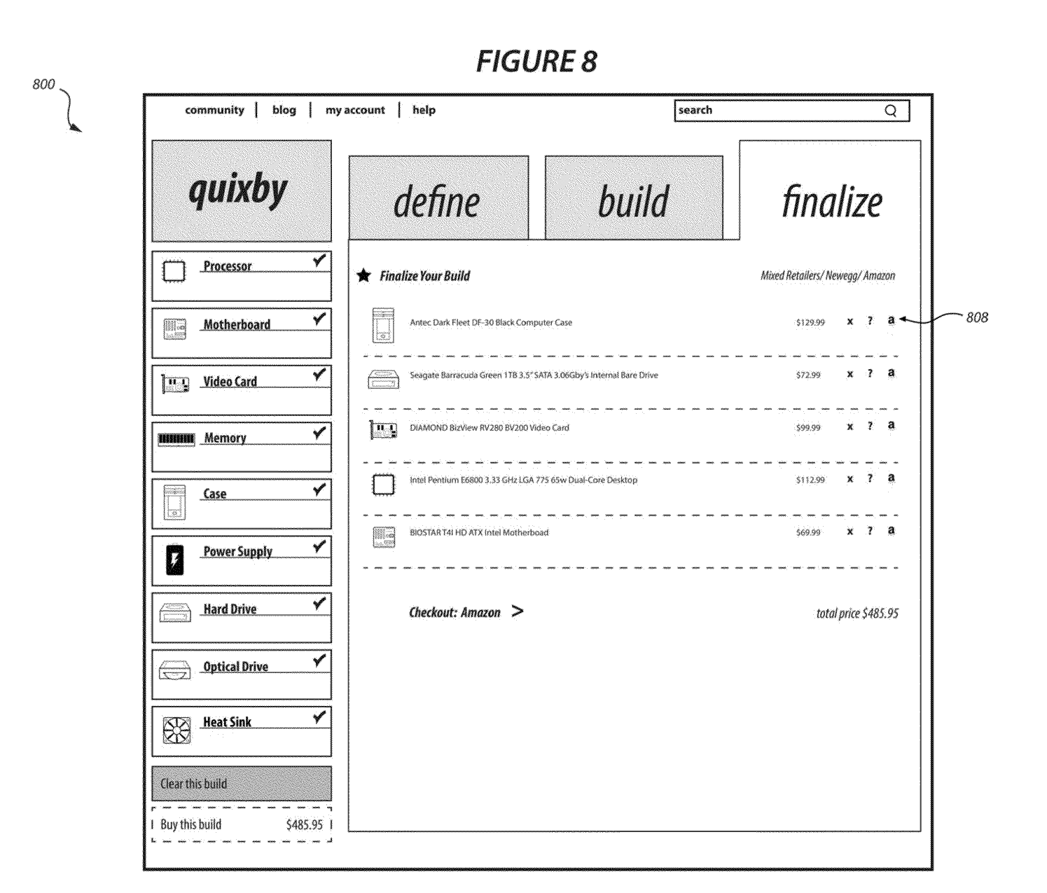

FIG. 8 is a schematic illustrating an exemplary display 800 of an alternative build in which components from the first vendor are replaced with similar components from a second vendor.

The components listed in the display 800 are sold by Amazon® whereas these components were listed in the display 700 of FIG. 7 are sold by Newegg®. In some embodiments, the replacement components in FIG. 8 may be the latest version of components listed in FIG. 7.

In addition, a system and method consistent with the present disclosure may also include a “system scan,” In some embodiments, a software application can be downloaded from a website hosted by control server 110. The downloaded software application can upload hardware details of the user's system to control server 110.

The system scan may be particularly useful if the user desires to purchase a replacement component for the user's computer system. Once control server 110 obtains a list of hardware components of the user's system, control server 110 may recommend compatible components and replacement parts to the user.

Control server 110 can determine which components have the lowest degree of functionality when compared to other similar components. The criteria for selecting the components with the lowest degree of functionality may be based on objective standards, such as processor speed, or based on subjective standards such as consumer reviews.

For example, a user's computer system may have a video card sufficient for word processing, but may not be ideal for computer gaming. Accordingly, control server 110 may identify the deficient video card from the system scan and in response recommend a higher grade video card to the user.

Control server 110 may alert the user that an (1) existing component may or may not be sufficient for the user's system or (2) one or more of the user's system components require upgrade to play one or more games. If upgrades are required, control server 110 may recommend components that will be compatible with the user's existing system.

In some embodiments, the system scan may help the user address system problems. For example, the system scan may identify any component(s) tending to define the slowest/weakest aspects of the user's system. Based on this determination, control server 110 can recommend replacement components that will remedy the user's system.

The system scan herein described can be initiated by various methods. For example, the system scan can initiate on a user's system when a user selects a system scan link on a website hosted by control server 110.

In addition, a system scan may be performed each time a user's system reboots. For instance, once a system reboots, typically a system notification is generated which reports any new hardware added to the system. The downloaded software application can retrieve this information and upload it to control server 110.

Systems and methods consistent with the present disclosure may also provide a means to pre-check all combinations of components before recommending them to the user using live data (e.g. possibly thousands of assessments for a particular user). The exemplary embodiment described above is also operable to store combinations of components for future evaluation. This aspect of functionality provided by the exemplary embodiment eliminates the need to check compatibility step by step, and rather, makes it possible to have the user's needs pre-solved (e.g. before the display of options to the user).

Systems and methods for presenting component recommendations to consumers based on submitted preference(s) have been described. It will be understood that the descriptions of some embodiments of the present disclosure do not limit the various alternative, modified and equivalent embodiments which may be included within the spirit and scope of the present disclosure as defined by the appended claims. Furthermore, in the detailed description above, numerous specific details are set forth to provide an understanding of various embodiments of the present disclosure. However, some embodiments of the present disclosure may be practiced without these specific details. In other instances, well known methods, procedures, and components have not been described in detail so as not to unnecessarily obscure aspects of the present embodiments.

1. A method, comprising:
collecting a plurality of component information of at least one component or sale by at least one vendor;
in response from a requester requesting component recommendations, retrieving component information, which was previously collected, of a first set of components relevant to the request; and
communicating the retrieved component information to the requester.

2. The method of claim 1 further comprising receiving a request for component recommendation from the requester wherein the request includes a description or requirement of a desired component.

3. The method of claim 1 further comprising determining whether to store each collected component information of the at least one component for sale in a database based on a result of a comparison between the collected component information and the component information presently stored in the database.

4. The method of claim 1 further comprising retrieving and communicating to the requester component information of a second set of components which are compatible with any of the components of the first set of components selected by the requester.

5. The method of claim 1, wherein collecting the plurality of component information includes scraping a website which provides component information sold by the at least one vendor.

6. The method of claim 1, wherein the at least one component for sale by the at least one vendor may be a component of one or more of a personal computer, gaming computer system, laptop, touch screen device, vehicle, custom-built home, or a single book of a series.

7. The method of claim 1, wherein the plurality of component information includes one or more of technical specifications, price information, retailer information, quantity information, or availability.

8. The method of claim 1, wherein the requester requests component recommendations via an online interface.

9. The method of claim 1 further comprising categorizing the plurality of component information into one of a plurality of categories.

10. The method of claim 1 further comprising storing compatibility information for each component represented by the collected component information.

11. The method of claim 1 further comprising utilizing a scraper software application to re-format the collected component information before storing the collected component information into a database.

12. A system, comprising:
a control server;
a second server coupled to the control server via a first network;
wherein the control server operates to retrieve a plurality of component information from the second server;
a computing system coupled to the control sever via a second network; and
wherein the computing system operates to request and retrieve component information from the second server.

13. The method of claim 12, wherein the control server is a vendor server.

14. The method of claim 12, wherein the control server includes a repository of component information collected from the second server.

15. The method of claim 12, wherein at least one of the first or second networks include one or more of the internet or an intranet.

16. The method of claim 12, wherein the computing system is at least one of a personal computer, laptop, mobile phone, or touch screen device.

17. A method, comprising:
a means for retrieving specifications of each component of a first computing system;
a means for identifying compatible components for each component of the first computing system based on the retrieved specifications; and
a means for communicating component information of each compatible component to the requester.

18. The method of claim 17 further comprising downloading a software application on the first computing system which enables the first computing system to send the specifications of each component to the second computing system.

19. The method of claim 17 further comprising a means for identifying replacement components for each component of the first computing system.

20. The method of claim 17 further comprising a means of ranking each component of the first computing system based on comparing how similar each component of the first computing system is to each identified replacement component.
